(19) United States
(12) Patent Application Publication
(10) Pub. No.: US 2017/0238764 A1
(43) Pub. Date: Aug. 24, 2017

(54) REUSABLE THERMAL INSULATING CONTAINER SLEEVE

(71) Applicant: Jean Cardinal-Marchand, Niagara-on-the-Lake (CA)

(72) Inventor: Jean Cardinal-Marchand, Niagara-on-the-Lake (CA)

(21) Appl. No.: 15/052,846

(22) Filed: Feb. 24, 2016

(51) Int. Cl. A47J 41/00; B65D 81/38

(52) U.S. Cl. CPC A47J 41/0061; B65D 81/3837

(57) ABSTRACT

Described is a reusable thermal insulating container sleeve. The reusable thermal insulating container sleeve is composed of an insulating polymer material and at least one thermally reflective material attached to the insulating polymer material. These materials increase the thermal insulating properties of the sleeve. The materials also prevent the buildup of condensation on the cup which is a common problem among other cup sleeves. The materials are also malleable, durable, and foldable, which permit the sleeve to be reusable. Furthermore, various embodiments of the invention include a sleeve that has a top and/or bottom portion which would cover the bottom of the beverage and further increase the thermal insulating properties of the sleeve. Finally, the present invention includes a method of insulating beverages.

### BACKGROUND

The present invention relates to a container sleeve. In particular, the present invention relates to a reusable thermal insulating container sleeve. Disposable beverages containers, such as paper cups, aluminum cans, glass and plastic bottles, are widely used. These containers are typically designed for either hot beverages such as coffee or tea, or cold beverages such as beer or soda. However, these containers typically have poor insulating properties which result in undesirable heat transfer. At times, the person holding the hot beverages can even experience discomfort and scalding due to the poor insulting properties of the disposable beverages containers.

Conventional cup sleeves are disposable and made of poor thermal insulating material. There are various disposable thermal insulating container sleeves, however, the disposable nature of these sleeves cause significant material waste and environmental pollution. The resulting material waste and environmental pollution makes them undesirable for most environmentally conscious consumers. Conversely, reusable cup sleeves typically have poor insulating properties and are bulky. By being bulky, the reusable cup sleeves are inconvenient to carry. None of the known insulated cup sleeves, however, are an effective reusable thermal insulating cup sleeve that are malleable, durable, and foldable. Therefore, there is a need for a convenient reusable container sleeve that can prevent undesirable heat transfer from beverages.

### BRIEF SUMMARY

The present invention provides a reusable container sleeve comprising of a side wall composed of an at least one insulating polymer material and at least one thermally reflective material attached to an insulating polymer material for insulating a beverage contained that is operatively placed within the sleeve. The side wall of the container sleeve can cover a portion or the entire length of the side wall of the beverage container placed within the sleeve.

The present invention further provides a reusable container sleeve that has a top and/or bottom portion which would cover the top or bottom of the beverage and further thermally insulate the beverage.

The present invention further includes a reusable container sleeve where the bottom portion has openings for drainage.

The present invention further includes a reusable container sleeve where the sleeve is adjoined via adhesive or stitching.

The present invention further includes a reusable container sleeve where promotional advertising can be placed on the container sleeve.

The present invention further includes a reusable container sleeve where the top ridge of the container sleeve is formed of a durable polymer material.

The present invention also includes a method of manufacturing a reusable container sleeve.

### BRIEF DESCRIPTION OF THE DRAWINGS

The accompanying drawings, which are included to provide a further understanding of the disclosed subject matter, are incorporated in and constitute a part of this specification. The drawings also illustrate aspects of the disclosed subject matter and together with the detailed description serve to explain the principles of the disclosed subject matter. No attempt is made to show structural details in more detail than may be necessary for a fundamental understanding of the disclosed subject matter and various ways in which it may be practiced.

FIG. 1 shows a cross-sectional view of an embodiment of the material used with a reflective material on both sides of insulating polymer material.

FIG. 2 shows a top view of an embodiment of the present invention in the unassembled state with an optional bottom portion.

FIG. 3 shows a top view of another of an embodiment of the present invention in the unassembled state with an optional top portion and optional bottom portion where the optional bottom portion has at least one optional drainage opening.

FIG. 4 shows a top-front perspective view of an embodiment of the container sleeve mounted on a beverage can.

FIG. 5 shows a top-front perspective view of an embodiment of the container sleeve mounted on a beverage cup.

FIG. 6 shows a top-front perspective view of an embodiment of the container sleeve mounted on a beverage can with stitching being used to adjoin the container sleeve.

FIG. 7 shows a top-front perspective view of an embodiment of the container sleeve mounted on a beverage cup with stitching being used to adjoin the container sleeve.

FIG. 8 shows a top-front perspective of an embodiment of the container sleeve with stitching being used to adjoin the container sleeve.

FIG. 9 shows a top-front perspective of an embodiment of the container sleeve with a durable polymer material being used to form the ridge and stitching being used to adjoin the container sleeve.

### DETAILED DESCRIPTION

The present invention provides a reusable thermal insulating container sleeve. When a beverage container is operatively placed within the sleeve, the reusable container sleeve maintains the temperature of the beverage for an extended period of time by preventing undesirable heat transfer between the beverage and the external environment. Although the reusable container sleeve can be any suitable size or shape, in the preferred embodiment, the reusable container sleeve is made for receiving commonly used beverage containers. These beverages containers can include paper cups, aluminum cans, glass and plastic bottles, all of which typically have poor insulting properties.

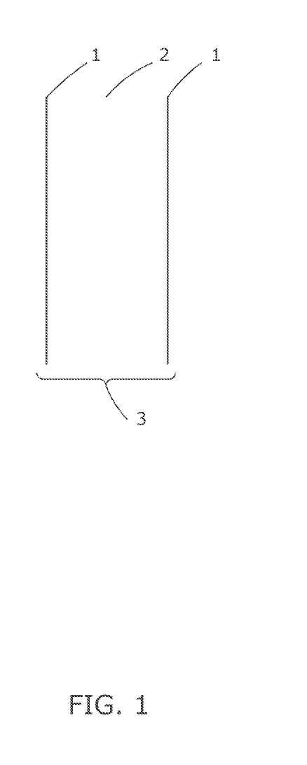

FIG. 1 shows a cross-sectional view of an embodiment of the material used with a reflective material being placed on both sides of insulating polymer material. The material used to form the cup sleeve is fundamental to the present invention. Conventional cup sleeves are disposable and made of poor thermal insulating material. The side wall 3 of the reusable container sleeve is comprised of a material composed of various layers that are connected together. Where layer means a single thickness of material covering a surface. The material includes at least one thermally insulating polymer layer 2 and at least one thermally reflective layer 2. In one embodiment of the present invention, the thermally reflective layer 1 is exterior to the thermally insulating polymer layer 2 when viewed from the perspective of the beverage container. In another embodiment of the present invention, the thermally insulating polymer layer 2 is sandwiched between two thermally reflective layers 1.

The material formed from the various layers have a number of functional purposes. The thermally insulating polymer layer 2 is preferably high density closed cell polyethylene foam. In addition to assisting in insulting the beverage container, the thermally insulating polymer layer 2 provides support to the reusable container sleeve to maintain its shape and integrity. The layers can be connected by an adhesive glue which is able to withstand a wide variety of temperatures. Any other suitable adhesion method may be used.

The thermally reflective layer 1 is preferably aluminum vapor or aluminum foil and assists in insulating the beverage container through the use of heat reflection. Specifically, the thermally reflective layer 1 inhibits thermal losses caused by thermal radiation by reflecting any radiant heat back at the beverage container. The properties of the materials also prevent condensation or sweat buildup from occurring. The materials also prevent the operator's hand from being scalded by the exterior surface of the beverage and provides a soft grip for the operator's hand.

The thermally insulating polymer layer 2 and thermally reflective layer 1 is also multi-purposed. In addition to inhibiting thermal losses, the materials are water-resistant, stain resistant and easy to clean. Thus, should the beverage spill onto the reusable container sleeve, the reusable container sleeve can be easily cleaned. The water-resistant materials also make the material antimicrobial.

In additional to being durable, the materials selected for the present invention are also collapsible, malleable, and foldable. These features of the material are integral to making the product reusable and solve the problem caused by previous disposable cup sleeves, namely the material waste and environment pollution produced there from. There are various disposable thermal insulating container sleeves, however, the disposable nature of these sleeves cause significant material waste and environmental pollution. The resulting material waste and environmental pollution make them undesirable for environmentally conscious consumers. The materials are also flame retardant.

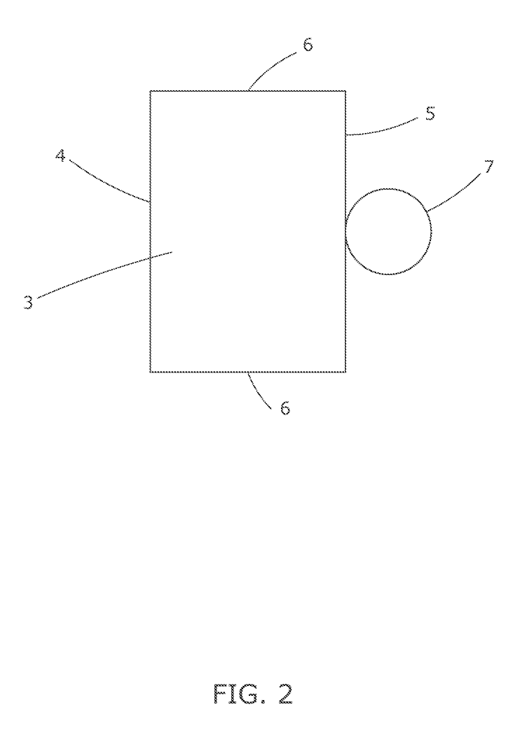

FIG. 2 shows a top view of an embodiment of the present invention in the unassembled state with an optional bottom portion 7. In the unassembled state of the basic embodiments of the invention, the side wall 3 has a top edge 4, bottom edge 5 and two side edges 6. To assemble the basic embodiment of the invention, the side edges 6 of the side wall 3 are adjoined together. This adjoining may be accomplished by an adhesive glue which is able to withstand a wide variety of temperatures. Any other suitable adhesion method may be used. The side edges 6 may even be adjoined by a zipper, hooks, clasps or buttons.

In the unassembled state, the present invention makes packaging and shipping the container sleeve easier and less costly. The present invention also includes a method of forming the beverage sleeve on site to allow for easy storage.

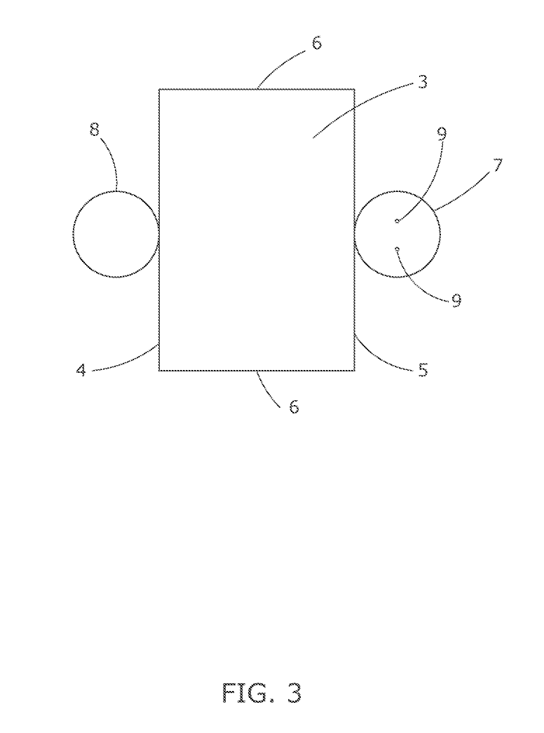

FIG. 3 shows a top view of another embodiment of the present invention in the unassembled state with an optional top portion 8 and optional bottom portion 7 where the optional bottom portion 7 has at least one optional drainage opening 9. In yet another implementation, the present invention further provides for a reusable container sleeve that has a top portion 8 and/or bottom portion 7. In additional to thermally insulating the beverage, the bottom portion 7 of the container sleeve can act as a coaster for the beverage. The bottom portion 7 may also have drainage openings 9 placed within the material to allow for drainage.

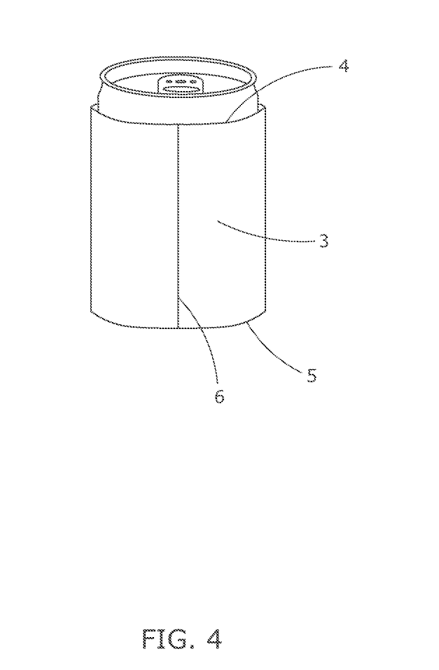

FIG. 4 shows a top-front perspective view of an embodiment of the container sleeve mounted on a beverage can. In a basic embodiment of the present invention, the reusable container sleeve is made up of a side wall 3 defining an annular cylinder with a top opening and a bottom opening for coaxial attachment around a wall of the beverage container. A container sleeve in this shape can be used for receiving cans.

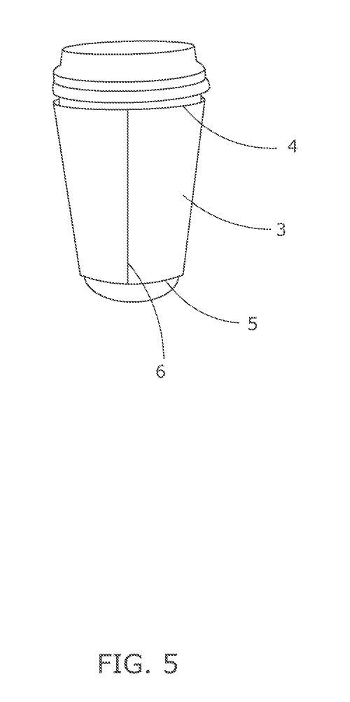

FIG. 5 shows a top-front perspective view of an embodiment of the container sleeve mounted on a beverage cup. In another basic embodiment of the present invention, the reusable container sleeve is made up of a side wall 3 defining an annular conical frustum with a top opening and a bottom opening for coaxial attachment around the exterior wall of the beverage container. A container sleeve in this shape can be used for receiving cups.

Although the reusable container sleeve can be any suitable size or shape, in the preferred embodiment, the reusable container sleeve is made for receiving commonly used beverage containers. These beverages containers can be cans, cups and bottles. The side wall 3 of the reusable cup sleeve can cover a portion or the entire length of the side wall 3 of the beverage container within the sleeve.

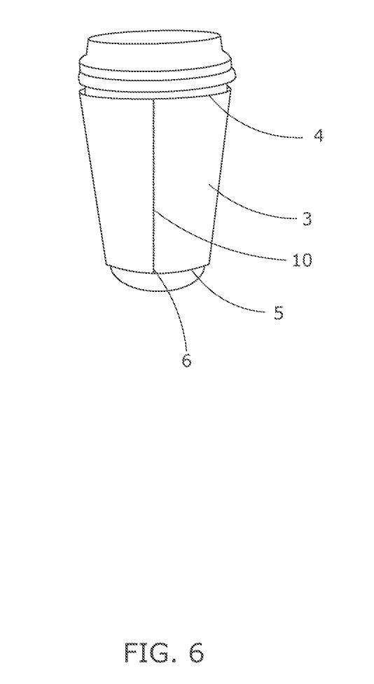

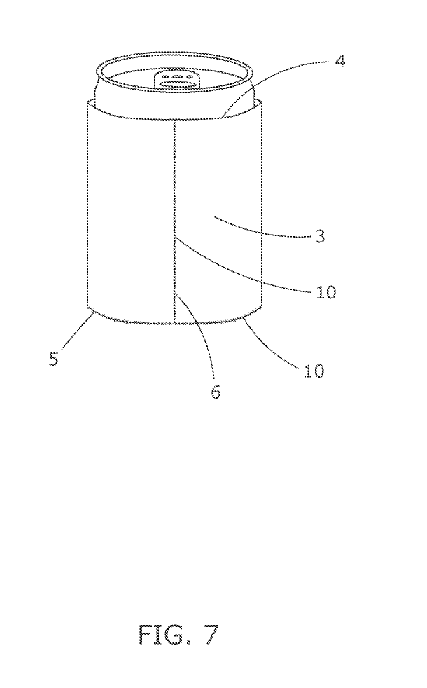

FIG. 6 shows a top-front perspective view of an embodiment of the container sleeve mounted on a beverage can with stitching being used to adjoin the container sleeve. FIG. 7 shows a front perspective of an embodiment of the container sleeve mounted on a beverage cup with stitching being used to adjoin the container sleeve. In yet another implementation, the reusable container sleeve can be adjoined by stitches 10 along the various edges and/or portions together.

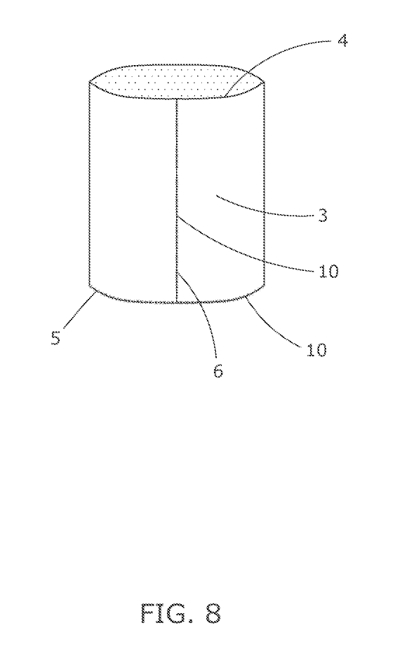

FIG. 8 shows a top-front perspective view of an embodiment of the container sleeve with stitching being used to adjoin the container sleeve. In yet another implementation, the present invention has promotion advertising placed on the reusable container sleeve to allow for the reusable container sleeve to be used for marketing and sponsorship purposes. The reusable container sleeve may also have a built in thermometer to demonstrate the temperature of the beverage within the reusable container sleeve. The reusable container sleeve may also have a handle or slits cut within it to allow for a beverage container with a handle to be inserted within it.

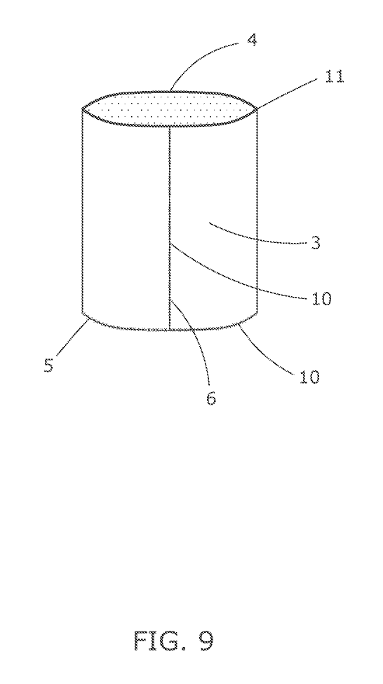

FIG. 9 shows a top-front perspective view of an embodiment of the container sleeve with a durable polymer material 11 being used to form the ridge and stitches 10 being used to adjoin the container sleeve. In yet another implementation, the reusable container sleeve can also have a polymer or rubber ridge 11 on the edges of it to further increase structural support.

The present invention also includes a method of manufacturing a reusable container sleeve.

Reusable cup sleeves typically have poor insulating properties and are bulky. By being bulky, the reusable cup sleeves are inconvenient to carry. None of the known insulated cup sleeves, however, are an effective reusable thermal insulating cup sleeve that is malleable, durable, and foldable. Therefore, there is a need for a convenient reusable container sleeve that can prevent undesirable heat transfer from beverages.

Moreover, references to “one implementation,” “an implementation,” “an example implementation,” and the like, indicate that the implementation described may include a particular step, feature, structure, or characteristic, but every implementation may not necessarily include the particular step, feature, structure, or characteristic. Moreover, such phrases are not necessarily referring to the same implementation. Further, when a particular step, feature, structure, or characteristic is described in connection with an implementation, such step, feature, structure, or characteristic may be included in other implementations whether or not explicitly described. The term “substantially” may be used herein and may be interpreted as “as nearly as practicable”, “within technical limitations”, and the like. In addition, the term “or” may be used herein and may be interpreted as “and/or” unless stated otherwise.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby

1. A reusable sleeve for beverage containers, comprising:
a side wall defining an annular cylinder with a top opening and a bottom opening for coaxial attachment around a wall of the beverage container composed of;
at least one insulating polymer material; and
at least one thermally reflective material attached to the insulating polymer material.

2. A reusable sleeve for beverage containers, comprising:
a side wall defining an annular conical frustum with a top opening and a bottom opening for coaxial attachment around a wall of the beverage container composed of;
at least one insulating polymer material; and
at least one thermally reflective material attached to the insulating polymer material.

3. The reusable container sleeves of claims 1 and 2, wherein said reusable sleeve has a bottom portion with a bottom wall enclosing the bottom opening of the reusable container sleeve.

4. The reusable container sleeve of claims 1 to 3, where said wherein said reusable sleeve has a top portion with a top wall enclosing the top opening of the reusable container sleeve.

5. The reusable container sleeve of claims 1 to 4, where said sleeve is adjoined by adhesive.

6. The reusable container sleeve of claims 1 to 4, where said sleeve is adjoined by stitch.

7. The reusable container sleeve of claims 1 to 4, where said sleeve is adjoined by zipper.

8. The reusable container sleeve of claims 1 to 4, where said sleeve is adjoined by hooks.

9. The reusable container sleeve of claims 1 to 4, where said sleeve is adjoined by clasps.

10. The reusable container sleeve of claims 1 to 4, where said sleeve is adjoined by buttons.

11. The reusable container sleeve of claims 1 to 4, wherein said bottom portion has holes to permit drainage.

12. The reusable container sleeve of claims 1 to 11, wherein said sleeve has a durable polymer material placed on the edges of the sleeve.

13. The reusable container sleeve of claims 1 to 12, wherein said reusable sleeve has advertising placed on it.

14. A method for insulating a beverage, comprising of operatively placing a beverage in a container sleeve composed of an insulating polymer material and at least one thermally reflective material attached to the insulating polymer material.
